(19) United States
(12) Patent Application Publication
(10) Pub. No.: US 2007/0069440 A1
(43) Pub. Date: Mar. 29, 2007

(54) VICE

(76) Inventor: Kuo-Chuan Lin, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/162,812

(22) Filed: Sep. 23, 2005

(51) Int. Cl. B25B 5/00

(52) U.S. Cl. 269/246

(57) ABSTRACT

There is disclosed a vice including a workbench, a stationary jaw installed on the workbench, a seat installed on the workbench, a screw inserted through the tunnel and a movable jaw attached to the screw. The seat defines a tunnel, a space in communication with the tunnel and a cavity in communication with the space. A lock is put in the space for movement between an engagement position and a disengagement position. In the engagement position, the lock is engaged with the screw so that rotation of the screw relative to the lock causes their relative movement. In the disengagement position, the lock is disengaged from the screw so that the screw can be moved relative to the lock freely. A key is put in the cavity for moving the lock between the engagement position corresponding to a fine-tuning step and the disengagement position corresponding to a quick adjustment step.

### BACKGROUND OF INVENTION

1. Field of Invention

The present invention relates to a vice and, more particularly, to a vice operable in a quick adjustment step and a fine-tuning step.

2. Related Prior Art

Disclosed in Taiwanese Patent Publication No. 478431 is a useful and convenient vice including a seat 10, a screw 20, a tube 30, a ring 40, a connector 50, a movable jaw 60 and a restraint 70.

The seat 10 is securely installed on a workbench while a stationary jaw is also securely installed on the workbench. The seat 10 includes a tubular clamp 11.

The tube 30 is inserted through the tubular clamp 11.

The ring 40 is fit in the tube 30 so that the ring 40 is stationary relative to the tube 30. On the internal surface of the ring 40 is formed with a thread 44.

The screw 20 is inserted through the tube 30 and the ring 40. The screw 20 includes a thread 23 engaged with the thread 44 of the ring 40. Rotation of the screw 20 relative to the ring 40 results in their relative movement.

The connector 50 includes an end connected to the screw 20 and an opposite end connected to the movable jaw 60.

The restraint 70 is engaged with the tubular clamp 11. The restraint 70 in a direction in order to cause the tubular clamp 11 to hold the tube 30 firmly. The restraint 70 can be rotated in an opposite direction in order to cause the tubular clamp 111 to release the tube 30.

Therefore, the position of the movable jaw 60 can be adjusted in two steps. Firstly, quick adjustment is done through the movement of the tube 30 relative to the seat 10 under the control of the clamp 11 and the restraint 70. Secondly, fine-tuning is conducted through the movement of the screw 20 relative to the tube 30 under the control of the threads 23 and 44. However, a few problems have been encountered during the use of the vice. Firstly, its cost is high for involving a complicated structure including a lot of elements that are assembled in a lengthy process. Secondly, it is not durable since the tubular clamp 11 cannot hold the tube 30 firmly when they wear away each other after some of use. Thirdly, larges forces exerted during the assembling process would degrade the performance of the tubular clamp 11 on the tube 30 during the use.

The present invention is therefore intended to obviate or at least alleviate the problems encountered in prior art.

### SUMMARY OF INVENTION

According to the present invention, a vice includes a workbench, a stationary jaw installed on the workbench, a seat installed on the workbench, a screw inserted through the tunnel and a movable jaw attached to the screw. The seat defines a tunnel, a space in communication with the tunnel and a cavity in communication with the space. A lock is put in the space for movement between an engagement position and a disengagement position. In the engagement position, the lock is engaged with the screw so that rotation of the screw relative to the lock causes their relative movement. In the disengagement position, the lock is disengaged from the screw so that the screw can be moved relative to the lock freely. A key is put in the cavity for moving the lock between the engagement position corresponding to a fine-tuning step and the disengagement position corresponding to a quick adjustment step.

An advantage of the according to the present invention is its low cost for including only a few elements that can be assembled in a short period of time.

Other advantages and novel features of the invention will become more apparent from the following detailed description in conjunction with the drawings.

### BRIEF DESCRIPTION OF DRAWINGS

The present invention will be described through detailed illustration of the preferred embodiment referring to the drawings.

FIG. 1 is a perspective view of a perspective view of a vice according to the preferred embodiment of the present invention.

FIG. 2 is a partial exploded view of the vice shown in FIG. 1.

FIG. 3 is a cross-sectional view of the vice shown in FIG. 1.

FIG. 4 is similar to FIG. 3 but shows the vice in a different position.

FIG. 5 is similar to FIG. 4 but shows the vice in a different position.

### DETAILED DESCRIPTION OF PREFERRED EMBODIMENT

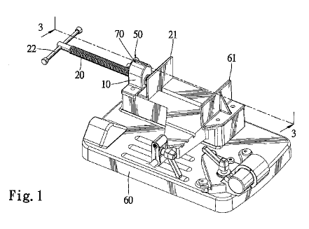

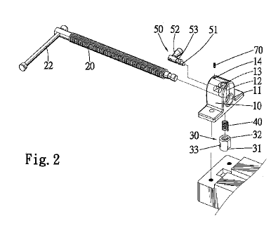

Referring to FIGS. 1 and 2, shown is a vice according to the preferred embodiment of the present invention. The vice includes a workbench 60, a stationary jaw 60, a seat 10, a screw 20, a movable jaw 21, a lock 30, a spring 40, a key 50 and a restraint 70.

The stationary jaw 61 is securely installed on the workbench 60.

The seat 10 is securely installed on the workbench 60. The seat 10 defines a tunnel 11, a space 12 in communicate with the tunnel 11 transversely, a cavity 13 in communication with the space 12 transversely and a hole 14 in communication with the cavity 13 transversely. The tunnel 11 goes through the seat 10. The space 12 includes a closed end at the top. The cavity 13 is parallel to but not in direct communication with the tunnel 11. The hole 14 is parallel to but not in direct communication with the space 12.

The screw 20 is inserted through the tunnel 11.

The movable jaw 21 is attached to an end of the screw 20. The rotation and resultant movement of the screw 20 results in the movement of the movable jaw 21.

A handle 22 is connected to an opposite end of the screw 20. The handle 22 facilitates the rotation of the screw 20.

A spring 40 is put in the space 12. An end of the spring 40 is against the closed end of the space 12.

The lock 30 is also put in the space 12 so that the spring 40 is compressed between the closed end of the space 12 and the lock 30. The lock 30 includes threads 31 for engagement with the screw 20, a first retaining portion 32 opposite to the threads 31 and a second retaining portion 33. As shown, the first retaining portion 32 is a recess for receiving an opposite end of the spring 40. However, in other embodiments, the first retaining portion 32 may be a stem inserted in the spring 40. In either case, the spring 40 is retained by means of the first retaining portion 32. The second retaining portion 33 is a recess.

The key 50 includes a driving portion 51 at an end and a handle 52 at an opposite end. The driving portion 51 is put in the second retaining portion 33. The driving portion 51 is a cam. Rotation of the key 50 results in movement of the block 30. The key 50 includes an annular groove 53 corresponding to the hole 14.

The restraint 70 is put in the annular groove 53 through the hole 14 so that the key 50 is restrained on the seat 10 but can be rotated. As shown, the restraint 70 is a screw, and the hole 14 is a screw hole for engagement with the restraint 70. However, in other embodiments, the restraint 70 may be a pin fit in the hole 14.

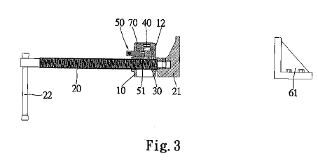

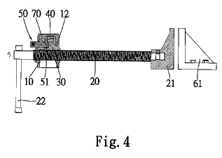

Referring to FIGS. 3 and 4, the key 50 is rotated in a direction in order to move the lock 30 to the screw 20. In this engagement position, the threads 31 are engaged with the thread of the screw 20 so that the rotation of the screw 20 relative to the lock 30 results in the movement of the screw 20 relative to the lock 30. The vice is in a fine-tuning step.

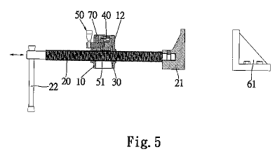

Referring to FIG. 5, the key 50 is rotated in an opposite direction in order to move the lock 30 from the screw 20. In this disengagement position, the threads 31 are disengaged from the thread of the screw 20. The rotation of the screw 20 relative to the lock 30 does not cause their movement relative to each other. However, the screw 20 can be moved relative to the lock 30 freely. The vice is in a quick adjustment step.

The spring 40 pushes the lock 30 to the screw 20. Therefore, even the lock 30 and the key 50 wear away each other after some time of use, the thread 31 can still be engaged with thread of the screw 20. Hence, the vice exhibits some advantages.

Firstly, its performance will not be degraded due to the wearing.

Secondly, its performance is not degraded due to forces exerted in the fabrication of the vice.

Thirdly, its cost is low for including only a few elements that can be assembled in a short period of time.

The present invention has been described through the detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A vice comprising:
a workbench;
a stationary jaw installed on the workbench;
a seat installed on the workbench, the seat defining a tunnel, a space in communication with the tunnel and a cavity in communication with the space;
a screw inserted through the tunnel;
a movable jaw attached to the screw;
a lock put in the space for movement between an engagement position where it is engaged with the screw so that rotation of the screw relative to the lock causes their relative movement and a disengagement position where it is disengaged from the screw so that the screw can be moved relative to the lock freely; and
a key put in the cavity for moving the lock between the engagement position corresponding to a fine-tuning step and the disengagement position corresponding to a quick adjustment step.

2. The vice according to claim 1 wherein the lock comprises threads for engagement with the screw.

3. The vice according to claim 1 comprising a handle connected to the screw in order to facilitate the rotation of the screw.

4. The vice according to claim 1 wherein the lock defines a recess, wherein the key comprises a driving portion put in the recess in order to enhance their interconnection.

5. The vice according to claim 4 wherein the driving portion is a cam in engagement with the wall of the recess.

6. The vice according to claim 1 comprising a spring compressed between a closed end of the space and the lock in order to push the lock toward the screw.

7. The vice according to claim 6 wherein the lock comprises a retaining portion for retaining the spring.

8. The vice according to claim 7 wherein the retaining portion is a recess for receiving an end of the spring.

9. The vice according to claim 1 comprising a restraint for restraining the key to the seat.

10. The vice according to claim 9 wherein the seat defines a hole in communication with the cavity so that the restraint is inserted into the cavity, for contact with the key, through the hole.

11. The vice according to claim 10 wherein the hole is a screw hole, wherein the restraint is a screw.
